(19) United States
(12) Patent Application Publication
(10) Pub. No.: US 2025/0212727 A1
(43) Pub. Date: Jul. 3, 2025

(54) SUPPORT SYSTEM FOR AN ELEMENT OF AN AGRICULTURAL HEADER

(71) Applicant: CNH Industrial America LLC, New Holland, PA (US)

(72) Inventor: Cory Douglas Hunt, Millersville, PA (US)

(21) Appl. No.: 18/867,175

(22) PCT Filed: May 23, 2023
(86) PCT No.: PCT/US2023/023258

§ 371 Date: Nov. 19, 2024

Related U.S. Application Data
(60) Provisional application No. 63/344,677, filed on May 23, 2022.

(51) Int. Cl. A01D 41/14

(52) U.S. Cl. CPC A01D 41/14

(57) ABSTRACT

A support system for an element of an agricultural header includes a support arm configured to support the element. The support arm is configured to extend along a forward longitudinal direction relative to a direction of travel of the agricultural header while the support arm is in an extended position. The support system also includes a pivot joint coupled to the support arm. The pivot joint is configured to pivotally couple the support arm to a frame of the agricultural header, the pivot joint is configured to enable the support arm to rotate from the extended position to a retracted position, and the support arm is configured to extend along a lateral direction relative to the direction of travel of the agricultural header while the support arm is in the retracted position.

### BACKGROUND

The present disclosure relates generally to a support system for an element of an agricultural header.

A harvester may be used to harvest agricultural crops, such as barley, beans, beets, carrots, corn, cotton, flax, oats, potatoes, rye, soybeans, wheat, or other plant crops. Furthermore, a combine (e.g., combine harvester) is a type of harvester generally used to harvest certain crops that include grain (e.g., barley, corn, flax, oats, rye, wheat, etc.). During operation of a combine, the harvesting process may begin by removing a plant from a field, such as by using a header. The header may cut the agricultural crops and transport the cut crops to a processing system of the combine.

Certain headers include a cutter bar assembly configured to cut a portion of each crop (e.g., a stalk), thereby separating the cut crop from the soil. The cutter bar assembly may extend along a substantial portion of a width of the header at a forward end of the header. The header may also include one or more belts positioned behind the cutter bar assembly relative to a direction of travel of the harvester. The belt(s) are configured to transport the cut crops to an inlet of the processing system. In addition, the header may include a reel assembly having a reel coupled to a frame of the header by multiple arms. The reel is configured to direct the crops cut by the cutter bar assembly toward the belt(s), thereby substantially reducing the possibility of the cut crops falling onto the surface of the field.

Certain headers include one or more sensors directed toward the surface of the field. The sensor(s) may be configured to monitor one or more properties of the field and/or a height of the header above the surface of the field. For example, one or more sensors may be coupled to at least one arm of the reel assembly. However, the header may not include any suitable structure for mounting sensor(s) laterally between the arms. Accordingly, it may be difficult to monitor property/properties of the field at certain locations along the lateral extent of the header.

### BRIEF DESCRIPTION

In certain embodiments, a support system for an element of an agricultural header includes a support arm configured to support the element. The support arm is configured to extend along a forward longitudinal direction relative to a direction of travel of the agricultural header while the support arm is in an extended position. The support system also includes a pivot joint coupled to the support arm. The pivot joint is configured to pivotally couple the support arm to a frame of the agricultural header, the pivot joint is configured to enable the support arm to rotate from the extended position to a retracted position, and the support arm is configured to extend along a lateral direction relative to the direction of travel of the agricultural header while the support arm is in the retracted position.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header;

FIG. 2 is a perspective view of an embodiment of a header that may be employed within the agricultural harvester of FIG. 1, in which the header includes a support system for sensors;

FIG. 3 is a perspective view of a portion of the header of FIG. 2, in which each support arm of the support system is in an extended position;

FIG. 4 is a top view of a portion of the header of FIG. 2, in which each support arm of the support system is in the extended position;

FIG. 5 is a perspective view of a portion of the header of FIG. 2, in which each support arm of the support system is in a retracted position; and

FIG. 6 is a top view of a portion of the header of FIG. 2, in which each support arm of the support system is in the retracted position.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

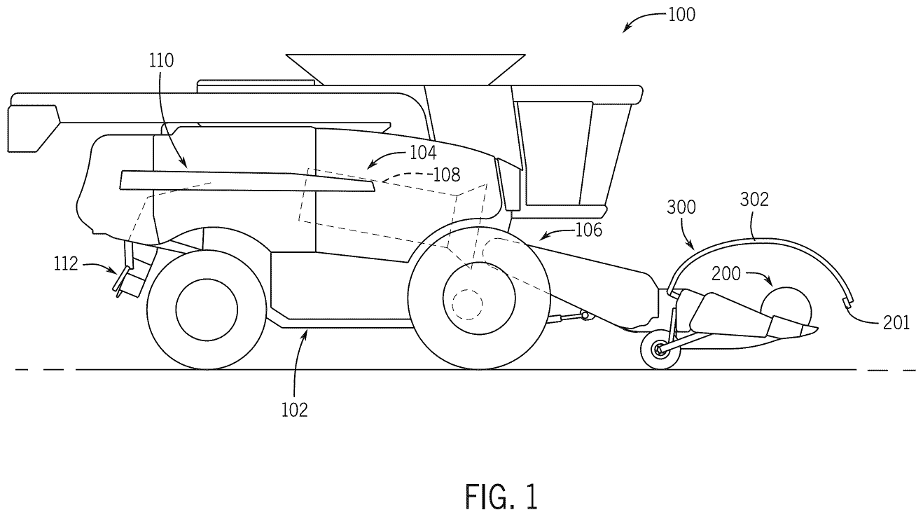

FIG. 1 is a side view of an embodiment of an agricultural harvester 100 having a header 200 (e.g., agricultural header). The agricultural harvester 100 includes a chassis 102 configured to support the header 200 and an agricultural crop processing system 104. As described in greater detail below, the header 200 is configured to cut crops and to transport the cut crops toward an inlet 106 of the agricultural crop processing system 104 for further processing of the cut crops. The agricultural crop processing system 104 receives cut crops from the header 200 and separates desired crop material from crop residue. For example, the agricultural crop processing system 104 may include a thresher 108 having a cylindrical threshing rotor that transports the crops in a helical flow path through the harvester 100. In addition to transporting the crops, the thresher 108 may separate certain desired crop material (e.g., grain) from the crop residue, such as husks and pods, and the thresher 108 may enable the desired crop material to flow into a cleaning system located beneath the thresher 108. The cleaning system may remove debris from the desired crop material and transport the desired crop material to a storage compartment within the harvester 100. The crop residue may be transported from the thresher 108 to a crop residue handling system 110, which may remove the crop residue from the harvester 100 via a crop residue spreading system 112 positioned at the aft end of the harvester 100.

As discussed in detail below, the header 200 includes a cutter bar assembly configured to cut the crops within the field. In certain embodiments, the cutter bar assembly is configured to flex along a width of the header to enable the cutter bar assembly to substantially follow contours of the field. In such embodiments, the cutter bar assembly is supported by multiple arms distributed along the width of the header. Each arm is pivotally mounted to a frame of the header, thereby enabling the cutter bar assembly to flex. To increase the flexibility of the cutter bar assembly, the frame may be divided into multiple sections that are pivotally coupled to one another. For example, the frame may include a center section, a first wing section positioned on a first lateral side of the center section, and a second wing section positioned on a second lateral side of the center section, opposite the first lateral side. The first wing section and the second wing section may each be pivotally coupled to the center section by a respective pivot joint. As a result, a flexible frame is formed, thereby increasing the flexibility of the cutter bar assembly.

In addition, the header 200 includes a reel assembly configured to urge crops cut by the cutter bar assembly to belts that convey the cut crops toward the inlet 106 of the agricultural crop processing system 104. As discussed in detail below, the reel assembly includes a reel having multiple fingers extending from a central framework. The central framework is driven to rotate such that the fingers engage the cut crops and urge the cut crops toward the belts. To enable the reel to flex with the header frame, the reel may include multiple sections coupled to one another by pivot joints. For example, the reel may include a center section (e.g., positioned forward of the center section of the header frame), a first wing section (e.g., positioned forward of the first wing section of the header frame), and a second wing section (e.g., positioned forward of the second wing section of the header frame). The first wing section and the second wing section of the reel may each be coupled to the center section of the reel by a respective pivot joint. As a result, a flexible reel is formed, thereby enabling the reel to flex with the header frame.

While a header frame having three sections and a reel having three sections is disclosed above, the header frame and the reel may have more or fewer sections. For example, the header frame and the reel may have 2, 4, 5, 6, or more sections, in which the header frame sections are pivotally coupled to one another, and the reel sections are pivotally coupled to one another. Furthermore, in certain embodiments, the header may have a single section, and the reel may have a single section. In such embodiments, the cutter bar may be substantially rigid along the width of the header.

In the illustrated embodiment, the header 200 includes one or more sensors 201 (e.g., element(s)) and a support system 300 configured to support the sensor(s) 201 (e.g., element(s)). The support system 300 includes one or more support arms 302, and each support arm 302 is coupled to one or more respective sensors 201. Each support arm 302 is configured to extend along a forward longitudinal direction relative to a direction of travel of the header 200/agricultural harvester 100 while the support arm 302 is in an extended position. In addition, each support arm 302 is configured to extend over the reel while the support arm is in the extended position. Accordingly, each support arm may position respective sensor(s) 201 at a location that enables the sensor(s) to monitor one or more properties of the field and/or a height of the header 200 above the surface of the field. The support system 300 also includes one or more pivot joints, in which each pivot joint is coupled to a respective support arm 302 and pivotally couples the respective support arm 302 to the frame of the header 200. Each pivot joint is configured to enable the respective support arm to rotate from the illustrated extended position to a retracted position. Each support arm 302 is configured to extend along a lateral direction relative to the direction of travel of the header 200/agricultural harvester 100 while the support arm 302 is in the retracted position.

Each support arm 302 may be rotated to the retracted position while the harvester 100 is in a transport configuration. For example, the harvester 100 may be transitioned to the transport configuration for movement along a public road (e.g., to move the harvester 100 between fields). Regulations may limit the total length and the total width of a harvester moving along a public road. Accordingly, rotating each support arm 302 from the illustrated extended position to the retracted position decreases the total length of the harvester 100, thereby satisfying the total length regulation and enabling the harvester 100 to move along a public road. In addition, while each support arm 302 is in the retracted position, an entirety of the support arm may overlap the header frame along the width of the header. As a result, the width of the harvester 100 is not increased while each support arm 302 is in the retracted position.

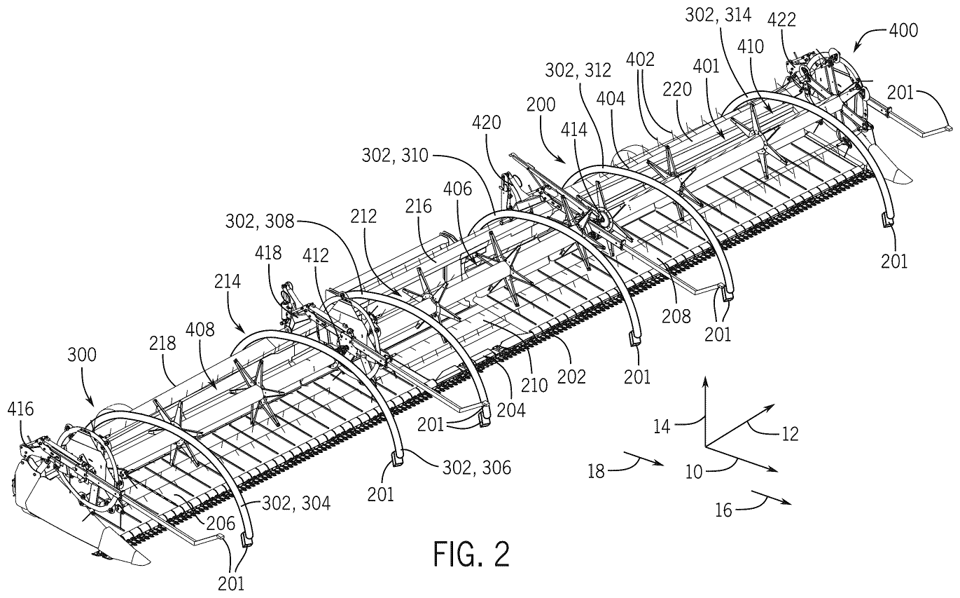

FIG. 2 is a perspective view of an embodiment of a header 200 that may be employed within the agricultural harvester of FIG. 1, in which the header 200 includes a support system 300 for sensors 201. In the illustrated embodiment, the header 200 includes a cutter bar assembly 202 configured to cut a portion of each crop (e.g., a stalk), thereby separating the crop from the soil. The cutter bar assembly 202 is positioned at a forward end of the header 200 relative to a longitudinal axis 10 of the header 200. As illustrated, the cutter bar assembly 202 extends along a substantial portion of the width of the header 200 (e.g., the extent of the header 200 along a lateral axis 12). The cutter bar assembly includes a blade support, a stationary guard assembly, and a moving blade assembly. The moving blade assembly is fixed to the blade support (e.g., above the blade support along a vertical axis 14 of the header 200), and the blade support/moving blade assembly is driven to oscillate relative to the stationary guard assembly. In the illustrated embodiment, the blade support/moving blade assembly is driven to oscillate by a driving mechanism 204 positioned at the lateral center of the header 200. However, in other embodiments, the blade support/moving blade assembly may be driven by another suitable mechanism (e.g., located at any suitable position on the header). As the harvester is driven through a field along a direction of travel 16 (e.g., which may be aligned with the longitudinal axis 10 of the header 200), the cutter bar assembly 202 engages crops within the field, and the moving blade assembly cuts the crops (e.g., the stalks of the crops) in response to engagement of the cutter bar assembly 202 with the crops.

In the illustrated embodiment, the header 200 includes a first lateral belt 206 on a first lateral side of the header 200 and a second lateral belt 208 on a second lateral side of the header 200, opposite the first lateral side. Each belt is driven to rotate by a suitable drive mechanism, such as an electric motor or a hydraulic motor. The first lateral belt 206 and the second lateral belt 208 are driven such that the top surface of each belt moves laterally inward. In addition, the header 200 includes a longitudinal belt 210 positioned between the first lateral belt 206 and the second lateral belt 208 along the lateral axis 12. The longitudinal belt 210 is driven to rotate by a suitable drive mechanism, such as an electric motor or a hydraulic motor. The longitudinal belt 210 is driven such that the top surface of the longitudinal belt 210 moves rearwardly along the longitudinal axis 10.

In the illustrated embodiment, the crops cut by the cutter bar assembly 202 are directed toward the belts by a reel assembly 400, thereby substantially reducing the possibility of the cut crops falling onto the surface of the field. The reel assembly 400 includes a reel 401 having multiple fingers 402 extending from a central framework 404. The central framework 404 is driven to rotate such that the fingers 402 move (e.g., in a circular pattern). The fingers 402 are configured to engage the cut crops and urge the cut crops toward the belts. The cut crops that contact the top surface of the lateral belts are driven laterally inwardly to the longitudinal belt due to the movement of the lateral belts. In addition, cut crops that contact the longitudinal belt 210 and the cut crops provided to the longitudinal belt by the lateral belts are driven rearwardly along the longitudinal axis 10 due to the movement of the longitudinal belt 210. Accordingly, the belts move the cut agricultural crops through an opening 212 in the header 200 to the inlet of the agricultural crop processing system.

In the illustrated embodiment, the cutter bar assembly 202 is flexible along the width of the header 200 (e.g., the extent of the header 200 along the lateral axis 12). The cutter bar assembly 202 is supported by multiple arm assemblies distributed along the width of the header 200 (e.g., along the lateral axis 12 of the header 200). Each arm assembly is mounted to a frame 214 of the header 200 and includes an arm configured to rotate and/or move along the vertical axis 14 relative to the frame. Each rotatable/movable arm is coupled to the cutter bar assembly 202, thereby enabling the cutter bar assembly 202 to flex during operation of the harvester. The flexible cutter bar assembly may follow the contours of the field, thereby enabling the cutting height (e.g., the height at which each crop is cut) to be substantially constant along the width of the header 200 (e.g., the extent of the header 200 along the lateral axis 12).

In the illustrated embodiment, the frame 214 is divided into multiple sections that are pivotally coupled to one another, thereby increasing the flexibility of the cutter bar assembly 202. As illustrated, the frame 214 includes a center section 216, a first wing section 218 positioned on a first lateral side of the center section 216 (e.g., along the lateral axis 12), and a second wing section 220 positioned on a second lateral side of the center section 216, opposite the first lateral side (e.g., along the lateral axis 12). The first wing section 218 and the second wing section 220 are each pivotally coupled to the center section 216 by a respective pivot joint. As a result, a flexible frame 214 is formed, thereby increasing the flexibility of the cutter bar assembly 202.

In the illustrated embodiment, the reel 401 includes multiple sections coupled to one another by pivot joints to enable the reel 401 to flex with the header frame. As illustrated, the reel 401 includes a center section 406 (e.g., positioned forward of the center section 216 of the header frame 214 along the longitudinal axis 10), a first wing section 408 (e.g., positioned forward of the first wing section 218 of the header frame 214 along the longitudinal axis 10), and a second wing section 410 (e.g., positioned forward of the second wing section 220 of the header frame 214 along the longitudinal axis 10). The first wing section 408 is pivotally coupled to the center section 406 by a first pivot joint 412, and the second wing section 410 is pivotally coupled to the center section 406 by a second pivot joint 414. As a result, a flexible reel 401 is formed, thereby enabling the reel 401 to flex with the header frame 214.

In the illustrated embodiment, the first wing section 408 of the reel 401 is supported by a first arm 416 coupled to the first wing section 218 of the frame 214, the center section 406 of the reel 401 is supported by a second arm 418 and a third arm 420 each coupled to the center section 216 of the frame 214, and the second wing section 410 of the reel 401 is supported by a fourth arm 422 coupled to the second wing section 220 of the frame 214. In certain embodiments, an actuator is coupled to each arm and configured to drive the arm to rotate about the respective local lateral axis, thereby controlling a position of the reel 401 relative to the frame 214 along the vertical axis 14 (e.g., to control engagement of the fingers of the reel with the cut agricultural crops).

While the header frame 214 and the reel 401 have three sections in the illustrated embodiment, in other embodiments, the header frame and the reel may have more or fewer sections. For example, the header frame and the reel may have 2, 4, 5, 6, or more sections, in which the header frame sections are pivotally coupled to one another, and the reel sections are pivotally coupled to one another. Furthermore, in certain embodiments, the header may have a single section, and the reel may have a single section. In such embodiments, the reel may be supported by two arms positioned on opposite lateral sides of the header frame. Additionally or alternatively, the cutter bar may be substantially rigid along the width of the header.

In the illustrated embodiment, the header 200 includes multiple sensors 201. In certain embodiments, at least one sensor 201 may be configured to monitor one or more properties of the field. For example, the field property sensor(s) may be configured to monitor soil moisture content, soil composition, soil density, soil compaction, crop height, crop density, crop width, other suitable properties of the field, or a combination thereof. The field property sensor(s) may include any suitable type(s) of sensor(s), such as optical sensor(s), passive infrared sensor(s), active infrared sensor(s), light detection and ranging (LiDAR) sensor(s), radio detection and ranging (RADAR) sensor(s), microwave sensor(s), millimeter wave sensor(s), ultrasonic sensor(s), capacitive sensor(s), electrostatic sensor(s), other suitable type(s) of sensor(s), or a combination thereof. In addition, in certain embodiments, at least one sensor 201 may be configured to monitor a height of the header 200 (e.g., a height of the header frame 214) above the surface of the field (e.g., along the vertical axis 14). The header height sensor(s) may include any suitable type(s) of sensor(s), such as RADAR sensor(s), LiDAR sensor(s), ultrasonic sensor(s), other suitable type(s) of sensor(s), or a combination thereof. In the illustrated embodiment, the header 200 includes ten sensors 201. However, in other embodiments, the header may include more or fewer sensors.

In the illustrated embodiment, one sensor 201 is coupled to the first reel support arm 416, one sensor 201 is coupled to the second reel support arm 418, one sensor 201 is coupled to the third reel support arm 420, and one sensor 201 is coupled to the fourth reel support arm 422. The reel support arms are configured to position the sensors 201 at locations suitable for monitoring the field property/properties and/or the height of the header 200 above the surface of the field. In the illustrated embodiment, each reel support arm positions the respective sensor 201 forward of the reel along the longitudinal axis 10 (e.g., along the direction of travel 16). Accordingly, the surface of the field is positioned within the field of view of the sensors. However, in other embodiments, at least one reel support arm may position at least one respective sensor at another suitable location for monitoring the field property/properties and/or the height of the header above the surface of the field. While each reel support arm is coupled to a single sensor in the illustrated embodiment, in other embodiments, at least one reel support arm may be coupled to more or fewer sensors (e.g., 0, 2, 3, 4, 5, 6, or more).

In certain embodiments, at least one reel support arm (e.g., all of the reel support arms or a portion of the reel support arms) may be configured to transition to a retracted position while the harvester is in the transport configuration. For example, during operation of the harvester, each reel support arm may be in an extended position, as illustrated, thereby positioning the sensors in suitable locations for monitoring the field property/properties and/or the height of the header above the surface of the field. As previously discussed, the harvester may be transitioned to the transport configuration for movement along a public road. Retracting each reel support arm from the illustrated extended position to the retracted position decreases the total length of the harvester, thereby satisfying the total length regulation and enabling the harvester to move along a public road. In certain embodiments, at least one reel support arm may include a telescoping mechanism to facilitate extension and retraction of the reel support arm. Additionally or alternatively, at least one reel support arm may include another suitable mechanism that enables extension and retraction of the reel support arm. Furthermore, in certain embodiments, at least one reel support arm may not be retractable (e.g., in embodiments in which the reel support arm does not extend forwardly beyond the cutter bar assembly along the direction of travel).

In the illustrated embodiment, the header 200 includes a support system 300 configured to support additional sensor(s) 201 laterally between the sensors supported by the reel support arms. Accordingly, the lateral regions outside of the field of view of the sensors supported by the reel arms may be monitored by the sensors supported by the support system. As a result, a significantly larger lateral portion of the field may be monitored (e.g., as compared to a header only having sensors coupled to the reel support arms).

As previously discussed, the support system 300 includes one or more support arms 302, and each support arm 302 is configured to support one or more respective sensors 201. In the illustrated embodiment, the support system 300 includes a first support arm 304 configured to support a single respective sensor 201, and the support system 300 includes a second support arm 306 configured to support a single respective sensor 201. The first support arm 304 is configured to extend along a forward longitudinal direction 18 relative to the direction of travel 16 of the agricultural header while the first support arm 304 is in the illustrated extended position. In addition, the first support arm 304 is configured to extend over the reel 401 of the header 200 while the first support arm 304 is in the extended position. Furthermore, the second support arm 306 is configured to extend along the forward longitudinal direction 18 relative to the direction of travel 16 of the header 200 while the second support arm 306 is in the illustrated extended position, and the second support arm 306 is configured to extend over the reel 401 of the header 200 while the second support arm 306 is in the extended position.

As used herein, “forward longitudinal direction” refers to a direction that extends generally along the direction of travel. For example, in certain embodiments, the forward longitudinal direction may be within 30 degrees of the direction of travel, the forward longitudinal direction may be within 25 degrees of the direction of travel, the forward longitudinal direction may be within 20 degrees of the direction of travel, the forward longitudinal direction may be within 15 degrees of the direction of travel, the forward longitudinal direction may be within 10 degrees of the direction of travel, the forward longitudinal direction may be within 5 degrees of the direction of travel, the forward longitudinal direction may be within 2 degrees of the direction of travel, or the forward longitudinal direction may be within 1 degree of the direction of travel. Furthermore, in certain embodiments, the longitudinal axis 10 of the header 200 may be substantially aligned with (e.g., within 1, 2, 3, 4, or 5 degrees of) the direction of travel, such that the forward longitudinal direction extends generally along the longitudinal axis 10. For example, the forward longitudinal direction may be within 30 degrees of the longitudinal axis, the forward longitudinal direction may be within 25 degrees of the longitudinal axis, the forward longitudinal direction may be within 20 degrees of the longitudinal axis, the forward longitudinal direction may be within 15 degrees of the longitudinal axis, the forward longitudinal direction may be within 10 degrees of the longitudinal axis, the forward longitudinal direction may be within 5 degrees of the longitudinal axis, the forward longitudinal direction may be within 2 degrees of the longitudinal axis, or the forward longitudinal direction may be within 1 degree of the longitudinal axis.

As discussed in detail below, the support system 300 includes a first pivot joint coupled to the first support arm 304. The first pivot joint pivotally couples the first support arm 304 to the first wing section 218 of the header frame 214, and the first pivot joint is configured to enable the first support arm 304 to rotate from the illustrated extended position to a retracted position. The first support arm 304 is configured to extend along a first lateral direction relative to the direction of travel 16 of the header 200 while the first support arm 304 is in the retracted position. Furthermore, the support system 300 includes a second pivot joint coupled to the second support arm 306. The second pivot joint pivotally couples the second support arm 306 to the first wing section 218 of the header frame 214, and the second pivot joint is configured to enable the second support arm 306 to rotate from the illustrated extended position to a retracted position. The second support arm 306 is configured to extend along a second lateral direction, opposite the first lateral direction, relative to the direction of travel of the agricultural header while the second support arm is in the retracted position. As previously discussed, the harvester may be transitioned to the transport configuration for movement along a public road (e.g., to move the harvester between fields). Rotating each support arm 302 from the illustrated extended position to the retracted position decreases the total length of the harvester (e.g., extent of the harvester along the longitudinal axis 10, extent of the harvester along the direction of travel 16, etc.), thereby satisfying the total length regulation and enabling the harvester to move along a public road.

As used herein, “lateral direction” refers to a direction that extends generally perpendicularly to the direction of travel. For example, in certain embodiments, the lateral direction may be within 30 degrees of an axis perpendicular to the direction of travel, the lateral direction may be within 25 degrees of the axis perpendicular to the direction of travel, the lateral direction may be within 20 degrees of the axis perpendicular to the direction of travel, the lateral direction may be within 15 degrees of the axis perpendicular to the direction of travel, the lateral direction may be within 10 degrees of the axis perpendicular to the direction of travel, the lateral direction may be within 5 degrees of the axis perpendicular to the direction of travel, the lateral direction may be within 2 degrees of the axis perpendicular to the direction of travel, or the lateral direction may be within 1 degree of the axis perpendicular to the direction of travel. Furthermore, in certain embodiments, the lateral axis 12 of the header 200 may be substantially aligned with (e.g., within 1, 2, 3, 4, or 5 degrees of) the axis perpendicular to the direction of travel, such that the lateral direction extends generally along the lateral axis 12. For example, the lateral direction may be within 30 degrees of the lateral axis, the lateral direction may be within 25 degrees of the lateral axis, the lateral direction may be within 20 degrees of the lateral axis, the lateral direction may be within 15 degrees of the lateral axis, the lateral direction may be within 10 degrees of the lateral axis, the lateral direction may be within 5 degrees of the lateral axis, the lateral direction may be within 2 degrees of the lateral axis, or the lateral direction may be within 1 degree of the lateral axis.

Furthermore, in the illustrated embodiment, the support system 300 includes a third support arm 308, a fourth support arm 310, a fifth support arm 312, and a sixth support arm 314. Each support arm 302 is configured to support a single respective sensor 201, and each support arm 302 is configured to extend along the forward longitudinal direction 18 relative to the direction of travel 16 while the support arm 302 is in the extended position. In addition, each support arm 302 is configured to extend over the reel 401 while the support arm 302 is in the extended position. A respective pivot joint is coupled to each support arm 302, and the pivot joint pivotally couples the support arm 302 to the header frame 214. The pivot joints coupled to the third and fourth support arms pivotally couple the third and fourth support arms to the center section 216 of the header frame 214, and the pivot joints coupled to the fifth and sixth support arms pivotally couple the fifth and sixth support arms to the second wing section 220 of the header frame 214. Each pivot joint is configured to enable the respective support arm 302 to rotate from the illustrated extended position to the retracted position, and each support arm 302 is configured to extend along a lateral direction relative to the direction of travel 16 while the support arm 302 is in the retracted position.

While a single sensor 201 is coupled to each support arm 302 in the illustrated embodiment, in other embodiments, more or fewer sensors may be coupled to at least one support arm. For example, in certain embodiments, 0, 2, 3, 4, 5, 6, or more sensors may be coupled to at least one support arm. Furthermore, while each arm 302 is configured to support one or more sensors 201 in the embodiments disclosed herein, in other embodiments, at least one support arm may be configured to support at least one other element (e.g., alone or in combination with the sensor(s)). For example, in certain embodiments, at least one support arm may support one or more reflectors (e.g., mirror(s), metal plate(s), etc.), and each reflector may be configured to redirect a beam of electromagnetic radiation (e.g., visible light, radio frequency radiation, microwave radiation, etc.) from a sensor (e.g., coupled to the header frame) to the surface of the field and/or from the surface of the field to a sensor (e.g., coupled to the header frame), thereby facilitating monitoring of field property/properties and/or the height of the header above the surface of the field.

While two support arms 302 are coupled to each section of the header frame 214 in the illustrated embodiment, in other embodiments, more or fewer support arms may be coupled to at least one header frame section. For example, in certain embodiments, 0, 1, 3, 4, 5, 6, or more support arms may be coupled to at least one header frame section. In addition, in embodiments having more or fewer header frame sections, the support system may include any suitable number of support arms. For example, if the header frame includes a single section, the support system may include 1, 2, 3, 4, 5, 6, or more support arms to distribute the sensors along the width of the header between the sensors supported by the reel support arms (e.g., one real support arm on each lateral side of the header). Furthermore, in the illustrated embodiment, the header 200 includes a reel 401, and the support arms 302 are configured to extend over the reel 401 while the support arms 302 are in the extended position. However, in other embodiments, the harvester may not include a reel. In such embodiments, the support system may include support arm(s) configured to extend over a reel (e.g., to reduce costs associated with designing and manufacturing support arms having a different configuration). Alternatively, the support system may include support arm(s) that are not configured to extend over a reel while the support arm(s) are in the extended position (e.g., substantially straight support arm(s), etc.).

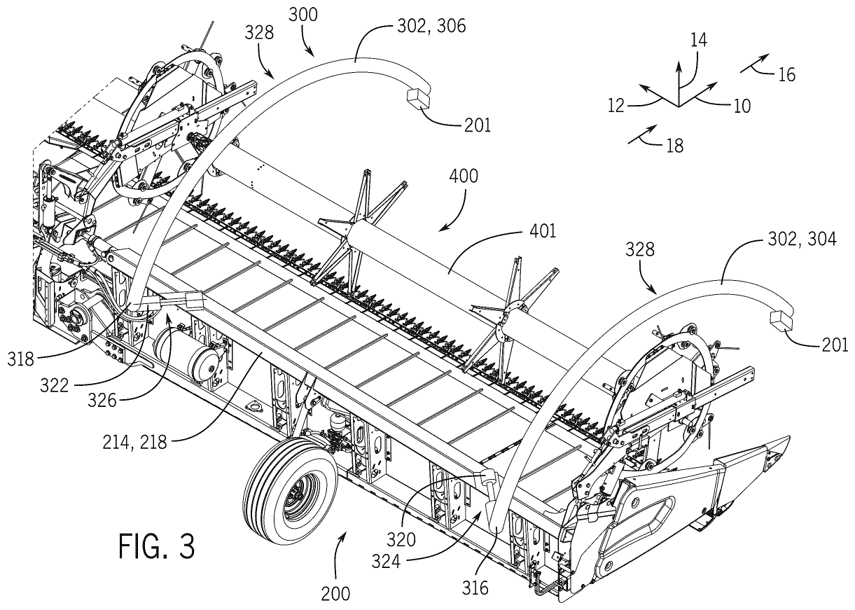

FIG. 3 is a perspective view of a portion of the header 200 of FIG. 2, in which each support arm 302 of the support system 300 is in an extended position. As illustrated, the first support arm 304 supports a respective sensor 201, and the first support arm 304 extends along the forward longitudinal direction 18 relative to the direction of travel 16 while the first support arm 304 is in the illustrated extended position. In addition, the first support arm 304 extends over the reel 401 while the first support arm 304 is in the extended position. In the illustrated embodiment, the support system 300 includes a first pivot joint 316 coupled to the first support arm 304. The first pivot joint 316 is configured to enable the first support arm 304 to rotate from the illustrated extended position to a retracted position. As discussed in detail below, the first support arm 304 is configured to extend along a first lateral direction relative to the direction of travel 16 while the first support arm 304 is in the retracted position. As used herein with regard to the support arms, “extend(s) along” refers to a direction of the support arm from the respective pivot joint toward the sensor (e.g., to the sensor in embodiments in which the sensor is positioned at the distal end of the support arm).

Furthermore, the second support arm 306 supports a respective sensor 201, and the second support arm 306 extends along the forward longitudinal direction 18 relative to the direction of travel 16 while the second support arm 306 is in the illustrated extended position. In addition, the second support arm 306 extends over the reel 401 while the second support arm 306 is in the extended position. In the illustrated embodiment, the support system 300 includes a second pivot joint 318 coupled to the second support arm 306. The second pivot joint 318 is configured to enable the second support arm 306 to rotate from the illustrated extended position to a retracted position. As discussed in detail below, the second support arm 306 is configured to extend along a second lateral direction relative to the direction of travel 16 while the second support arm 306 is in the retracted position.

In the illustrated embodiment, the support system 300 includes a first mounting arm 320 (e.g., mounting structure) non-rotatably coupled to the first wing section 218 of the header frame 214, and the first pivot joint 316 pivotally couples the first support arm 304 to the first mounting arm 320. Accordingly, the first pivot joint 316 pivotally couples the first support arm 302 to the header frame 214. In addition, the support system 300 includes a second mounting arm 322 (e.g., mounting structure) non-rotatably coupled to the first wing section 218 of the header frame 214, and the second pivot joint 318 pivotally couples the second support arm 306 to the second mounting arm 322. Accordingly, the second pivot joint 318 pivotally couples the second support arm 306 to the header frame 214. While the support system 300 includes a mounting arm for each support arm in the illustrated embodiment, in other embodiments, at least one support arm may be coupled to the header frame via another suitable type of mounting structure (e.g., mounting lug, mounting protrusion, etc.). Furthermore, in certain embodiments, at least one mounting arm/structure may be omitted. In such embodiments, the respective pivot joint may directly pivotally couple the respective support arm to the header frame.

In the illustrated embodiment, the support system 300 includes a first actuator 324 coupled to the first support arm 304. The first actuator 324 is configured to drive the first support arm 304 to rotate between the illustrated extended position and the retracted position. In addition, the support system 300 includes a second actuator 326 coupled to the second support arm 306. The second actuator 326 is configured to drive the second support arm 306 to rotate between the illustrated extended position and the retracted position. Each actuator may include any suitable device(s) configured to drive the respective support arm to rotate between the extended position and the retracted position. For example, the actuator may include an electric motor, an electric linear actuator, a hydraulic motor, a hydraulic cylinder, a pneumatic motor, a pneumatic cylinder, other suitable type(s) of actuating device(s), or a combination thereof. Furthermore, in the illustrated embodiment, each actuator is disposed within a respective mounting arm (e.g., mounting structure). However, in other embodiments, at least one actuator or at least a portion of at least one actuator may be positioned in any other suitable location (e.g., adjacent to the respective mounting arm/structure, etc.). Furthermore, while an actuator is coupled to each support arm in the illustrated embodiment, in other embodiments, at least one actuator may be omitted, and the respective support arm(s) may be manually rotated between the extended and retracted positions.

In certain embodiments, at least one pivot joint may include one or more mechanical stops configured to control rotation of the respective support arm. For example, in certain embodiments, at least one pivot joint (e.g., each pivot joint) may include a fixed mechanical stop configured to block rotation of the respective support arm beyond the extended position along a direction of rotation from the retracted position to the extended position. Additionally or alternatively, at least one pivot joint (e.g., each pivot joint) may include a fixed mechanical stop configured to block rotation of the respective support arm beyond the retracted position along a direction of rotation from the extended position to the retracted position. Furthermore, in certain embodiments, at least one pivot joint (e.g., each pivot joint) may include an engageable mechanical stop configured to selectively block rotation of the respective support arm from the extended position toward the retracted position while the respective support arm is in the extended position. Additionally or alternatively, at least one pivot joint (e.g., each pivot joint) may include an engageable mechanical stop configured to selectively block rotation of the respective support arm from the retracted position toward the extended position while the respective support arm is in the retracted position. At least one engageable mechanical stop may be selectively engaged and disengaged by a manual device (e.g., latch, lever, etc.) and/or an actuator (e.g., electromechanical actuator, pneumatic actuator, hydraulic actuator, etc.). In certain embodiments, at least one engageable mechanical stop may be automatically engaged via a suitable device (e.g., a latch that contacts the support arm, etc.). While mechanical stops configured to control rotation of a support arm are disclosed above, in certain embodiments, at least one pivot joint may include other and/or additional device(s) configured to control rotation of the respective support arm (e.g., a ratchet mechanism, a pin and slot assembly, a lockable gear system, etc.). Furthermore, in certain embodiments, at least one support arm (e.g., each support arm) may be held/maintained in at least one position by the actuator configured to drive the support arm to rotate between the extended and retracted positions (e.g., alone or in combination with a mechanical stop of the respective pivot joint). In addition, in certain embodiments, at least one support arm (e.g., each support arm) may be held/maintained in at least one position (e.g., the retracted position) by gravity. For example, the weight of the support arm may urge the support arm against a mechanical stop.

In the illustrated embodiment, each support arm 302 has a respective curved portion 328 configured to face upwardly (e.g., relative to the vertical axis 14) while the support arm 302 is in the extended position. The curved portion 328 of each support arm 302 is configured to enable the support arm 302 to extend over the reel 401, thereby enabling the support arm to position the respective sensor 201 in a suitable location for monitoring the field property/properties and/or the height of the header above the surface of the field. In certain embodiments, each pivot joint is configured to enable the curved portion to face downwardly while the respective support arm is in the retracted position. While each support arm has a respective curved portion in the illustrated embodiment, in other embodiments, at least one support arm may have another suitable shape (e.g., polygonal, angled, etc.) that enables the support arm to extend over the reel. While the support arms, pivot joints, mounting arms (e.g., mounting structures), actuators, and mechanical stops are disclosed herein with regard to the first and second support arms, the details, structures, and variations disclosed with regard to the first and second support arms may apply to each support arm of the support system.

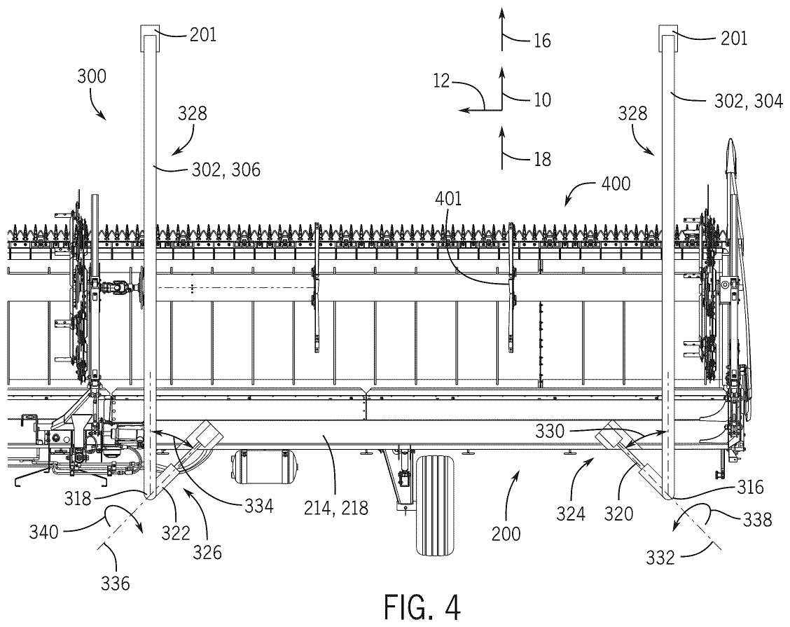

FIG. 4 is a top view of a portion of the header 200 of FIG. 2, in which each support arm 302 of the support system 300 is in the extended position. As previously discussed, the support system 300 includes a first mounting arm 320 (e.g., mounting structure) non-rotatably coupled to the first wing section 218 of the header frame 214, and the support system 300 includes a second mounting arm 322 (e.g., mounting structure) non-rotatably coupled to the first wing section 218 of the header frame 214. In the illustrated embodiment, the first mounting arm and the second mounting arm extend rearwardly relative to the forward longitudinal direction 18. Furthermore, in the illustrated embodiment, the first mounting arm 320 is oriented about 45 degrees (e.g., within 0.5 degrees of 45 degrees, within 1 degree of 45 degrees, within 2degrees of 45 degrees, or within 5 degrees of 45 degrees) relative to the forward longitudinal direction 18. Accordingly, an angle 330 between the forward longitudinal direction 18 and an axis 332 of the first mounting arm 320 is about 45 degrees. In addition, the second mounting arm 322 is oriented about 45 degrees (e.g., within 0.5 degrees of 45 degrees, within 1 degree of 45 degrees, within 2 degrees of 45 degrees, or within 5 degrees of 45 degrees) relative to the forward longitudinal direction 18. Accordingly, an angle 334 between the forward longitudinal direction 18 and an axis 336 of the second mounting arm 322 is about 45 degrees.

In the illustrated embodiment, the first pivot joint 316 is configured to enable the first support arm 304 to rotate in a first rotational direction 338 about 180 degrees (e.g., 170 degrees to 190 degrees, 175 degrees to 185 degrees, or 178 degrees to 182 degrees) about the axis 332 of the first mounting arm 320 between the illustrated extended position and the retracted position. Accordingly, the first support arm 304 rotates about a single axis between the extended and retracted positions. In addition, the second pivot joint 318 is configured to enable the second support arm 306 to rotate in a second rotational direction 340 about 180 degrees (e.g., 170 degrees to 190 degrees, 175 degrees to 185 degrees, or 178 degrees to 182 degrees) about the axis 336 of the second mounting arm 322 between the illustrated extended position and the retracted position. Accordingly, the second support arm 306 rotates about a single axis between the extended and retracted positions. Because each mounting arm is oriented at about 45 degrees relative to the forward longitudinal direction and the respective pivot joint is configured to enable the respective support arm to rotate about 180 degrees about the respective mounting arm axis, the curved portion of the respective support arm faces upwardly while the respective support arm is in the extended position, and the curved portion of the respective support arm faces downwardly while the respective support arm is in the retracted position.

While each pivot joint is configured to enable the respective support arm to rotate about 180 degrees about the respective mounting arm axis in the illustrated embodiment, in other embodiments, at least one pivot joint may enable the respective support arm to rotate more or less than 180 degrees about the respective mounting arm axis (e.g., based on the configuration of the mechanical stops, etc.). For example, in certain embodiments, at least one pivot joint may enable the respective support arm to rotate about 30 degrees, about 60 degrees, about 90 degrees, about 120 degrees, about 150 degrees, about 210 degrees, or about 240 degrees about the respective mounting arm axis. Furthermore, while each mounting arm is oriented about 45 degrees relative to the forward longitudinal direction in the illustrated embodiment, in other embodiments, at least one mounting arm may be oriented more or less than 45 degrees relative to the forward longitudinal direction. For example, in certain embodiments, an angle between the forward longitudinal direction and the axis of at least one mounting arm may be about 0 degrees, about 10 degrees, about 20 degrees, about 30 degrees, about 40 degrees, about 50 degrees, about 60 degrees, about 70 degrees, or about 80 degrees. In addition, while each mounting arm extends rearwardly relative to the forward longitudinal direction in the illustrated embodiment, in other embodiments, at least one mounting arm may extend forwardly or perpendicularly to the forward longitudinal direction. In addition, while each pivot joint is configured to enable the respective support arm to rotate about a respective single axis in the illustrated embodiment, in other embodiments, at least one pivot joint may be configured to enable the respective support arm to rotate about multiple axes. For example, in certain embodiments, at least one pivot joint may include a ball joint and/or multiple single-axis joints that enable the respective support arm to rotate about multiple axes between the illustrated extended position and the retracted position.

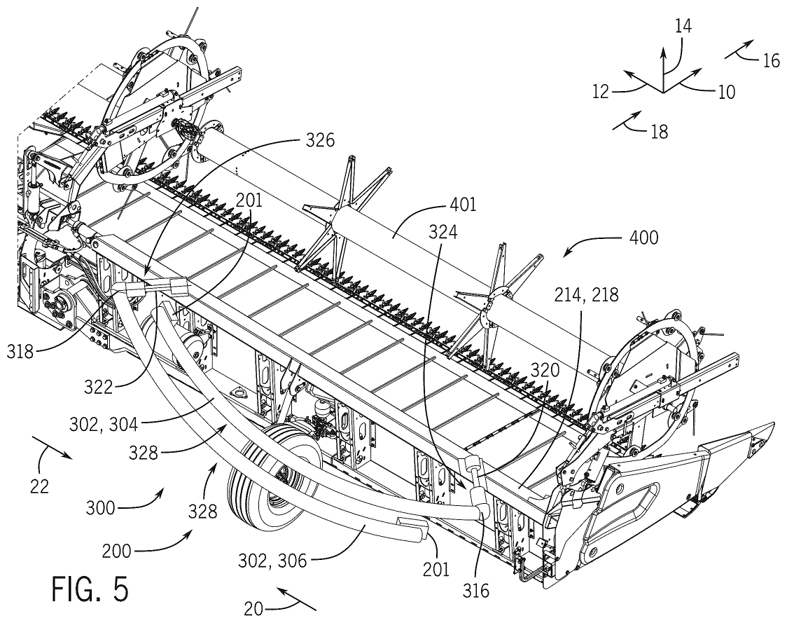

FIG. 5 is a perspective view of a portion of the header 200 of FIG. 2, in which each support arm 302 of the support system 300 is in a retracted position. As illustrated, with the first support arm 304 in the retracted position, the first support arm 304 extends along a first lateral direction 20 relative to the direction of travel 16 of the header 200. In addition, with the second support arm 306 in the illustrated retracted position, the second support arm 306 extends along a second lateral direction 22, opposite the first lateral direction 20, relative to the direction of travel 16 of the agricultural header 200. As previously discussed, regulations may limit the total length and the total width of a harvester moving along a public road. Accordingly, rotating each support arm 302 from the extended position to the illustrated retracted position decreases the total length of the harvester 100, thereby satisfying the total length regulation and enabling the harvester to move along a public road.

Furthermore, in the illustrated embodiment, while each support arm 302 is in the illustrated retracted position, an entirety of the support arm 302 overlaps the header frame 214 (e.g., the first wing section 218 of the header frame 214) along the width of the header 200 (e.g., along the lateral axis 12 of the header 200). As a result, the width of the harvester 100 is not increased while each support arm 302 is in the retracted position, thereby satisfying the total width regulation and enabling the harvester to move along a public road.

In the illustrated embodiment, the first pivot joint 316 is configured to enable the curved portion 328 of the first support arm 304 to face downwardly while the first support arm 304 is in the illustrated retracted position. In addition, the second pivot joint 318 is configured to enable the curved portion 328 of the second support arm 306 to face downwardly while the second support arm 306 is in the illustrated retracted position. Because the curved portions of the support arms face downwardly while the support arms are in the retracted position, the support arms may be positioned outside of a field of view of the operator, thereby enhancing operator visibility along the forward longitudinal direction 18. While each pivot joint is configured to enable the curved portion of the respective support arm to face downwardly while the respective support arm is in the retracted position in the illustrated embodiment, in other embodiments, at least one pivot joint may enable the curved portion to face another suitable direction (e.g., upwardly, etc.) while the respective support arm(s) are in the retracted position.

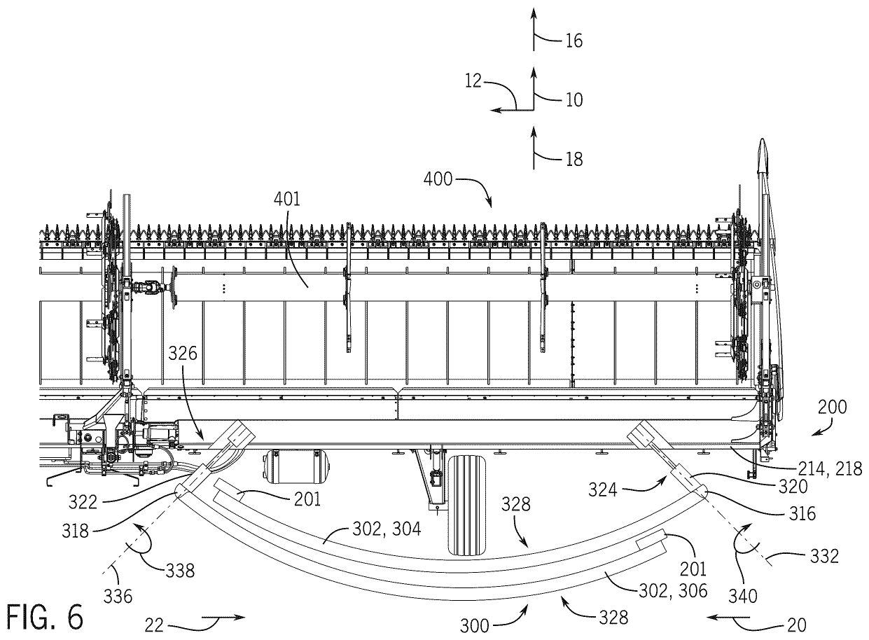

FIG. 6 is a top view of a portion of the header 200 of FIG. 2, in which each support arm 302 of the support system 300 is in the retracted position. As previously discussed, with the first support arm 304 in the retracted position, the first support arm 304 extends (e.g., from the first pivot joint 316 to the sensor 201) along a first lateral direction 20 relative to the direction of travel 16 of the header 200. In addition, with the second support arm 306 in the illustrated retracted position, the second support arm 306 extends (e.g., from the second pivot joint 318 to the sensor 201) along a second lateral direction 22, opposite the first lateral direction 20, relative to the direction of travel 16 of the agricultural header 200. In the illustrated embodiment, the first mounting arm 320 and the second mounting arm 322 are angled away from one another, thereby enabling the first support arm 304 to extend along the first lateral direction 20 and the second support arm 306 to extend along the second lateral direction 22. In the illustrated embodiment, the first mounting arm 320 is shorter than the second mounting arm 322, thereby enabling the support arms 302 to partially overlap one another along the longitudinal axis 10. As a result, the mounting arms/support arms may be positioned laterally closer to one another (e.g., as compared to a configuration in which each mounting arm is oriented at the same angle relative to the forward direction of travel). However, in other embodiments, at least one mounting arm may be oriented at another suitable angle relative to the forward longitudinal direction 18 (e.g., the longitudinal axis 10).

To transition the first support arm 304 from the illustrated retracted position to the extended position, the first support arm may be rotated in the second rotational direction 340 about the axis 332 of the first mounting arm 320. In addition, to transition the second support arm 306 from the illustrated retracted position to the extended position, the second support arm 306 may be rotated in the first rotational direction 338 about the axis 336 of the second mounting arm 322. As previously discussed, each support arm 302 may be rotated manually or by a respective actuator.

As previously discussed, in the illustrated embodiment, each mounting arm extends rearwardly relative to the forward longitudinal direction. However, in other embodiments, at least one mounting arm may extend forwardly or perpendicularly to the forward longitudinal direction. For example, in certain embodiments, at least one mounting arm (e.g., mounting structure) may extend forwardly relative to the forward longitudinal direction, and the respective pivot joint may enable the support arm to rotate from the extended position to a retracted position in which the support arm extends along a lateral direction and is positioned forward of the header frame (e.g., above a respective belt). Furthermore, while the pivot axis of each support arm corresponds to the axis of the respective mounting arm in the illustrated embodiment, in other embodiments (e.g., in embodiments that do not include mounting arm(s), etc.), the pivot axis of at least one support arm may be established by another suitable mounting arrangement. For example, a single axis pivot joint may be mounted at a desired angle on a mounting lug, a mounting protrusion, or another suitable mounting structure (e.g., mounting arm) couple to the header frame. Furthermore, a single axis pivot joint may be coupled directly to the header frame (e.g., at a rearwardly extending protrusion of the header frame or at a forwardly extending protrusion of the header frame) at a desired angle. In addition, while the first support arm extends along the first lateral direction and the second support arm extends along the second lateral direction while the support arms are in the retracted position in the illustrated embodiment, in other embodiments, the first support arm may extend along the second lateral direction and/or the second support arm may extend along the first lateral direction while the support arms are in the retracted position. For example, with regard to the support arms coupled to the center section of the header frame, the third support arm may extend along the second lateral direction and the fourth support arm may extend along the first lateral direction while the support arms are in the retracted position, such that the support arms extend laterally outward from one another (e.g., to enable the support arms to avoid header mounting components).

While only certain features have been illustrated and described herein, many modifications and changes will occur to those skilled in the art. It is, therefore, to be understood that the appended claims are intended to cover all such modifications and changes as fall within the true spirit of the disclosure.

1. A support system for an element of an agricultural header, comprising:
a support arm configured to support the element, wherein the support arm is configured to extend along a forward longitudinal direction relative to a direction of travel of the agricultural header while the support arm is in an extended position; and
a pivot joint coupled to the support arm, wherein the pivot joint is configured to pivotally couple the support arm to a frame of the agricultural header, the pivot joint is configured to enable the support arm to rotate from the extended position to a retracted position, and the support arm is configured to extend along a lateral direction relative to the direction of travel of the agricultural header while the support arm is in the retracted position.

2. The support system of claim 1, comprising a mounting structure configured to non-rotatably couple to the frame of the agricultural header, wherein the pivot joint pivotally couples the support arm to the mounting structure.

3. The support system of claim 2, wherein the mounting structure is configured to extend rearwardly relative to the forward longitudinal direction.

4. The support system of claim 3, wherein the mounting structure comprises a mounting arm configured to be oriented about 45 degrees relative to the forward longitudinal direction.

5. The support system of claim 4, wherein the pivot joint is configured to enable the support arm to rotate about 180 degrees about a single axis between the extended position and the retracted position.

6. The support system of claim 1, wherein the pivot joint is configured to enable the support arm to rotate about a single axis.

7. The support system of claim 1, wherein the support arm is configured to extend over a reel of the agricultural header while the support arm is in the extended position.

8. The support system of claim 7, wherein the support arm has a curved portion configured to face upwardly while the support arm is in the extended position to enable the support arm to extend over the reel.

9. The support system of claim 8, wherein the pivot joint is configured to enable the curved portion to face downwardly while the support arm is in the retracted position.

10. A support system for a plurality of elements of an agricultural header, comprising:
a first support arm configured to support a first element of the plurality of elements, wherein the first support arm is configured to extend along a forward longitudinal direction relative to a direction of travel of the agricultural header while the first support arm is in an extended position;
a first pivot joint coupled to the first support arm, wherein the first pivot joint is configured to pivotally couple the first support arm to a frame of the agricultural header, the first pivot joint is configured to enable the first support arm to rotate from the extended position of the first support arm to a retracted position, and the first support arm is configured to extend along a first lateral direction relative to the direction of travel of the agricultural header while the first support arm is in the retracted position of the first support arm;
a second support arm configured to support a second element of the plurality of elements, wherein the second support arm is configured to extend along the forward longitudinal direction relative to the direction of travel of the agricultural header while the second support arm is in an extended position; and
a second pivot joint coupled to the second support arm, wherein the second pivot joint is configured to pivotally couple the second support arm to the frame of the agricultural header, the second pivot joint is configured to enable the second support arm to rotate from the extended position of the second support arm to a retracted position, and the second support arm is configured to extend along a second lateral direction, opposite the first lateral direction, relative to the direction of travel of the agricultural header while the second support arm is in the retracted position of the second support arm.

11. The support system of claim 10, comprising:
a first mounting structure configured to non-rotatably couple to the frame of the agricultural header, wherein the first pivot joint pivotally couples the first support arm to the first mounting structure; and
a second mounting structure configured to non-rotatably couple to the frame of the agricultural header, wherein the second pivot joint pivotally couples the second support arm to the second mounting structure.

12. The support system of claim 11, wherein the first mounting structure and the second mounting structure are configured to extend rearwardly relative to the forward longitudinal direction.

13. The support system of claim 12, wherein the first mounting structure comprises a first mounting arm configured to be oriented about 45 degrees relative to the forward longitudinal direction, and the second mounting structure comprises a second mounting arm configured to be oriented about 45 degrees relative to the forward longitudinal direction.

14. The support system of claim 10, wherein the first support arm is configured to extend over a reel of the agricultural header while the first support arm is in the extended position of the first support arm, and the second support arm is configured to extend over the reel of the agricultural header while the second support arm is in the extended position of the second support arm.

15. The support system of claim 14, wherein the first support arm has a curved portion configured to face upwardly while the first support arm is in the extended position of the first support arm to enable the first support arm to extend over the reel, and the second support arm has a curved portion configured to face upwardly while the second support arm is in the extended position of the second support arm to enable the second support arm to extend over the reel.

16. The support system of claim 15, wherein the first pivot joint is configured to enable the curved portion of the first support arm to face downwardly while the first support arm is in the retracted position of the first support arm, and the second pivot joint is configured to enable the curved portion of the second support arm to face downwardly while the second support arm is in the retracted position of the second support arm.

17. An agricultural header, comprising:
a frame;
a reel rotatably coupled to the frame;
a sensor; and
a support system, comprising:
a support arm coupled to the sensor, wherein the support arm is configured to extend along a forward longitudinal direction relative to a direction of travel of the agricultural header while the support arm is in an extended position, and the support arm is configured to extend over the reel while the support arm is in the extended position; and
a pivot joint coupled to the support arm, wherein the pivot joint pivotally couples the support arm to the frame, the pivot joint is configured to enable the support arm to rotate from the extended position to a retracted position, and the support arm is configured to extend along a lateral direction relative to the direction of travel of the agricultural header while the support arm is in the retracted position.

18. The agricultural header of claim 17, wherein the support system comprises a mounting structure non-rotatably coupled to the frame of the agricultural header, and the pivot joint pivotally couples the support arm to the mounting structure.

19. The agricultural header of claim 18, wherein the mounting structure extends rearwardly relative to the forward longitudinal direction.

20. The agricultural header of claim 19, wherein the mounting structure comprises a mounting arm oriented about 45 degrees relative to the forward longitudinal direction.
